(19) United States
(12) Patent Application Publication
(10) Pub. No.: US 2002/0152997 A1
(43) Pub. Date: Oct. 24, 2002

(54) Method for controlling the release of fuel vapour from a tank ventilation system

(76) Inventors: Georg Buhl, Muenchen (DE); Markus Mueller, Groebenzell (DE); Andre Sell, Muenchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/089,690

(22) PCT Filed: Jul. 13, 2001
(86) PCT No.: PCT/EP01/08511

(30) Foreign Application Priority Data
Aug. 4, 2000 (DE) 10038243.6

(51) Int. Cl. F02M 33/02

(52) U.S. Cl. 123/520; 123/518

(57) ABSTRACT

The invention relates to a method for controlling the emission of fuel vapor from a fuel tank venting system in a preferably cylinder-specific intake duct of an internal, combustion engine, a control valve permitting the fuel vapor to reach the assigned intake duct synchronously with the intake cycle of the cylinder of the internal combustion engine, the opening time of the control valve being variable. Preferably, for controlling or metering larger amounts of fuel vapor, the opening time is placed in a range, in which there is a higher vacuum in the intake duct. On the other hand, for controlling or metering lesser amounts of fuel vapor, the opening time is placed in a range, in which there already is a lesser vacuum in the intake duct. The closing point of the control valve is also variable and this control valve is not opened, if there is excess pressure in the intake duct. Considered over several consecutive operating cycles of a cylinder, in starting out as a first emission of fuel vapor into the intake duct, the opening time for the subsequent cycles are shifted increasingly from regions of lesser vacuum into regions of higher vacuum.

The invention relates to a method for controlling the emission of fuel vapor from a fuel tank venting system in a preferably cylinder-specific intake duct of an internal combustion engine, a control valve permitting the fuel vapor to reach the assigned intake duct synchronously with the intake cycle of the cylinder of the internal combustion engine. For technical background, reference is made to the DE 196 11 521 A1.

It is well known that motor vehicles, driven by internal combustion engines, are provided not only with a fuel tank, but also with a fuel tank venting system, vapors, which are leased in the tank, being stored temporarily in a so-called hydrocarbon trap or in an activated charcoal filter and thus being prevented from reaching the environment. At time advantageous for the internal combustion engine or at suitable operating times of the internal combustion engine, the activated charcoal filter (or the like) is then flushed with a so-called flow of flushing air, with which the temporarily stored fuel vapors are supplied to the cylinders of the internal combustion engine for combustion. The time at which this takes place and the amount of fuel vapor of the internal combustion engine, stored temporarily, is determined by a so-called fuel tank venting valve, which preferably is constructed as a metering valve and is referred to below (as well as in the claims) in general as a control valve.

Different control methods are known for said control valve or tank venting valve. Generally, the latter is controlled in one or several fixed time patterns, these time patterns not being synchronized with the operating cycle of the cylinders of the internal combustion engine. The opening characteristics of the control valve, such as a valve constructed as a fixed cycle valve, put out by an electronic control unit, in collaboration with the vacuum existing in the intake duct of the internal, combustion engine (or of the cylinders of the internal combustion engine), then determine the amount of fuel vapor flowing through the control valve. One of the known systems works with a volume, which is upstream from the control valve and in which there is an almost continuous or, if considered over several working cycles, an almost constant vacuum. The individual cylinders of a multi-cylinder internal combustion engine are supplied from this volume. A different, known system works without such an upstream volume. In this case, all cylinders of the internal combustion engine are connected with one another and with the control valve or the tank venting valve over a hose system.

In the DE 196 11 521 A1, which is mentioned above and which was used to formulate the introductory portion of claim 1, a method is described for controlling the emission of fuel vapor from a fuel tank venting system over a cylinder-specific branched pipeline system to the intake ducts of a multi-cylinder internal combustion engine. In the pipeline system, a controllable valve is provided, which releases and blocks the emission. This valve is controlled so that the emission takes place synchronously with the periodical repetition of the working cycles of the internal combustion engine. By these means, the combustion of the fuel vapors in the internal combustion engine is evened out (over the individual cylinders of the internal combustion engine), in order to decrease exhaust emissions and to improve the efficiency of the combustion.

In the case of the first-mentioned state of the art, in which the control valve or tank venting valve is controlled in a fixed time pattern, it is not possible to assign the volume of flushing air and fuel vapors by means of this control valve to the individual cylinders of the internal combustion engine or to individual operating cycles of the cylinders, although this would be desirable—see the second state of the art named. Admittedly, in the case of the latter (DE 196 11 521 A1), an individual controlling system can be assigned to the control valve of an operating cycle of a cylinder of an internal combustion engine. Even here, however, further improvements are possible and it is an object of the present invention to point out such improvements.

The accomplishment of this object is characterized in that the time, at which the control valve is open, is variable. Advantageous further developments are given in the dependent claims.

Pursuant to the invention, it is now possible to select the position of the so-called flushing cross section, within which fuel vapors (together with flushing air) can be supplied to the intake duct of a cylinder of an internal combustion engine, in such a manner that the variation of pressure in this suction duct, as a function of time, can be taken into consideration. This is done pursuant to the invention by parameterizing the opening time of the control valve or of the tank venting valve. In this connection, it is pointed out that, of course, in addition to the opening time, as in the known state of the art, the closing time of this control valve can also be variable.

For a more detailed explanation of the invention, which is given in the following, reference is also made to FIG. 2, in which the course of the pressure in the intake duct of a cylinder of an internal compulsion engine is shown in a roughly generalized fashion for two different load points or operating points of the internal combustion engine. Furthermore, a device for carrying out the inventive method is shown in a highly simplified form in FIG. 1.

FIG. 1 shows a cylinder 1 of an internal combustion piston engine, the details of which are not given, is shown, into the combustion space 2 of which fresh gas, which is provided with fuel, is supplied for combustion by an intake duct 4, which can be closed off by an inlet valve 3. Furthermore, a throttle valve 5 or the like, by means of which the amount of fresh gas supplied to the combustion space 2 can be controlled, is provided in the intake duct 4.

Aside from the elements named above, a tank venting system, which is labeled 6 as a whole, is provided. For the system, the fuel vapors, arising in the fuel tank 7, can be stored temporarily in an activated charcoal filter 8, which is connected in a suitable manner with the fuel tank 7. Of course, this activated charcoal filter 8 must also be emptied or flushed once again. For this purpose, flushing air from the surroundings is passed through the activated charcoal filter 8, which takes up fuel vapors and passes these over a flushing pipeline 9 into the intake duct 4 of cylinder 1 of the internal combustion engine downstream from the throttle valve 5, so that these fuel vapors finally can be combusted (and, with that, utilized) in the combustion space 2 and thus utilized.

In the flushing pipeline 9, a control valve 10, which is also referred to as a fuel tank venting valve and is constructed as a fixed cycle valve, is provided, over which the amounts of flushing air, mixed with fuel vapor and reaching the intake duct 4, can be metered or determined. This control valve 10 is controlled in a suitable manner by an electronic control unit 11. In actual fact, it is not possible to pass an arbitrary amount of flushing air at all operating times of the internal combustion engine into the combustion space 2 or into the combustion spaces of a multi-cylinder internal combustion engine, since this flushing air, with an undefined proportion of fuel, interferes with the normal course of combustion.

In FIG. 2, the pressure p in the intake duct 4 of the cylinder 1 of the internal combustion engine is shown for two different load points or operating points in a roughly generalized form as a function of time t or of the crankshaft angle of the internal combustion piston engine. These two load points VL (=full load) and TL (=partial load) originate from different opening positions of the throttle valve 5 at a constant rpm of the internal combustion engine. The time span shown extends essentially over an intake cycle of the cylinder 1, during which the inlet valve 3 is open, so that fresh gas is aspirated into the combustion space 2 through the intake duct 4. Naturally, there is then a vacuum (relative to atmospheric pressure) in the intake duct 4 downstream from the throttle valve 5. Of course, the vacuum at full load (VL) is less than the vacuum at partial load (TL). At the same time, it can be seen that, under unchanged boundaries conditions, the vacuum in the intake duct 4 changes over time t, that is, the vacuum is less at the end of the operating cycle than at the start.

Knowing this state of affairs and taking it into consideration that, when the control valve 10 is open (FIG. 1) the amount of flushing air, which reaches the intake duct 4 and, in so doing, is mixed with the fuel vapor from the activated charcoal filter 8, is also determined by the pressure drop between the intake duct 4 and the surroundings, that is, by the magnitude of the vacuum in the intake duct 4, it is now proposed that the opening time of the control valve 10, which is to be opened in synchronizations with the intake cycle, be varied selectively and, moreover, in such a manner that there is optimum combustion in the combustion space 2 of the internal combustion engine. In FIG. 2, two different opening times t₁ and t₂ are shown for the control valve 10 at the partial load point TL, the duration of the opening Δt being the same in each case here. If the control valve 10 is opened at time t₁, the amount of flushing air, mixed with fuel vapor, which reaches the intake duct 4, is greater than the amount at time t₂.

Preferably, for controlling or metering larger amounts of fuel vapor, which are to be introduced by means of the so-called flushing air from the activated charcoal filter 8 into the intake duct 4, the opening time of the control valve 10 is shifted into a range, in which there is a higher vacuum in the intake duct 4. On the other hand, for controlling or metering smaller amounts of fuel vapor, the opening time is shifted into a range, in which there already is a lesser vacuum in the intake duct 4. With reference to FIG. 2, the control valve 10 is opened, for example, at time t₁ for the first-mentioned case, that is, large amounts of flushing air and fuel) since the driving pressure drop is larger here than at the later time t₂, at which, for example, the control valve 10 is opened in the case mentioned second, (that is, lesser amounts of flushing air and fuel). In the first case, a relatively large amount of flushing air and fuel vapor can be passed into the intake duct 4 in a simple manner, even if the opening time Δt is relatively short. On the other hand, the amount of fuel vapor (and flushing air) supplied can be metered more accurately in an advantageous manner in the second case, namely when the control valve 10 is opened at time t₂. Accordingly, if the control valve 10 is opened later, that is, at a time or in a range, in which there already is a lesser vacuum in the intake duct 4, the flushing air can be metered more accurately, by changing the period of time Δt, during which the control valve 10 is open, by an amount of the order of, for example, 10° of crankshaft angle, than it can at an earlier time, such as t₁, shortly after the inlet valve 3 is opened.

As already mentioned, aside from the opening time, also the closing time of the control valve 10 is variable for metering the amount of fuel vapor, which is supplied over the flushing air. Advantageously, it now becomes possible with the inventive method that this control valve 10 is not opened at all or when there is pressure in the intake duct.

In the sense of an advantageous further development of the invention, taking into consideration several consecutive operating cycles of one cylinder or of cylinder I and starting out from a first emission of fuel vapor into the intake duct 4, the opening time of the control valve 10 for the subsequent operating cycles can be shifted increasingly from a range of lesser vacuum in the intake duct to a range of higher vacuum in the intake duct. As already mentioned, the flushing of the activated charcoal filter 8 cannot be carried out at all operating points of the internal combustion engine. If this flushing is now started, there is, of course, a so-called first emission of fuel vapor in the intake duct 4, which should take place, as proposed, relatively late, in the intake cycle of the cylinder, so that the control valve 10 should be opened, for example, at the opening time t₂. In the subsequent operating cycles or intake cycles of this cylinder 1, the control valve 10 is then opened increasingly in ranges of lower vacuum in the intake duct, that is, in the direction of the opening time t₁, in order to make it possible for the control unit 11, which controls the control valve 10, to recognize the behavior of the system as a whole and react to it in a suitable manner, that is, to continue to control the control valve 10 in a suitable manner and, at the same time, to fix the duration Δt and the time of the opening of the control valve 10 in a suitable manner. For this purpose, the control unit 11 receives suitable feedback from the control electronics of the internal combustion engine, in which, as is generally known, the composition of the exhaust gas of the internal combustion engine is also analyzed. In particular, the unavoidable opening delay of the control valve 10, which elapses between an appropriate triggering of the control valve 10 and the actual opening, can be taken into consideration and compensated for with the method proposed.

In the sense of an advantageous further development of the invention, the amount of fuel vapor from the fuel tank venting system 6, supplied to a cylinder or to cylinder 1 can be changed by varying the opening time or the opening time and closing time of the control valve from operating cycle to operating cycle over several consecutive operating cycles, in order to improve the smoothness or the dynamic behavior of the internal combustion. The latter can be detected by using suitable sensors and an appropriate evaluation, as well as a subsequent triggering can then be carried out in or by the electronic control unit 11.

Furthermore, in the case of a multi-cylinder internal combustion engine, different amounts of fuel vapor from the fuel tank venting system can be supplied to the individual cylinders by varying the opening time or the opening time and closing times of the control valve. Furthermore, of course, additional modifications or addition to the above embodiments are possible without departing from the content of the claims. The inventive method always offers the possibility of controlling the control valve 10 or the fuel tank venting valve in synchronization with the crankshaft. Moreover, the opening and closing points of this control valve 10 can be placed so that these operations are controlled reproducibly in suitable positions of the crankshaft.

This proposed control advantageously permits the use of control valves with larger static flushing amounts or basic flow-through amounts. With that, it becomes possible to combine, without any disadvantages, the metering ability of a small control valve with the high flushing amount of a large control valve. Furthermore, the possibility exists of a cylinder-selective and working cycle-selective of the determination by the control valve 10 or the tank-venting valve, as well as the further advantages described.

1. A method for controlling the emission of fuel vapor from a fuel tank venting system (6) into a preferably cylinder-specific intake duct (4) of an internal combustion engine, a control valve (10 permitting the fuel vapor to reach the assigned intake duct (4) in synchronization with the intake cycle of the cylinder (1) of the internal combustion engine, wherein the opening time of the control valve (10) is variable.

2. The method of claim 1, wherein, for the control or metering of larger amounts of fuel vapor, the opening time is shifted into a range, in which a higher vacuum exists in the intake duct (4), while the opening time for controlling or metering smaller amounts of fuel vapor, is placed in a range in which there already is a lesser vacuum in the intake duct (4).

3. The method of claims 1 or 2, wherein the closing time of the control valve (10) is also variable and this control value (10) is not opened or open, when there is excess pressure in the intake duct (4).

4. The method of one of the preceding claims, wherein the opening time, considered over several consecutive operating cycles of a cylinder (1) and starting out from a first emission of fuel vapor into the fuel duct (4), is shifted increasingly for the subsequent operating cycles from a range of lesser vacuum in the intake duct to a range of higher vacuum intake.

5. The method of one of the preceding claims, wherein, when considered over several consecutive cycles of a cylinder (1), the amount of fuel vapor, supplied to cylinder (1) from the fuel tank venting system (6), is changed by varying the opening time or the opening and closing time of the control valve from operating cycle to operating cycle, in order to improve the smoothness or the dynamic behavior of the internal combustion engine.

6. The method of one of the preceding claims, wherein, in the case of a multi-cylinder combustion engine, different amounts of fuel vapor from the fuel tank venting system (6) are supplied to the individual cylinders by varying the opening time or the opening and closing time of the control valve.
